(19) United States
(12) Patent Application Publication
(10) Pub. No.: US 2018/0303063 A1
(43) Pub. Date: Oct. 25, 2018

(54) Process and system for tracking and locating livestock using a GPS device.

(71) Applicants: Russ Davis, Elk City, OK (US); Jim Hayes, Denver, CO (US)

(72) Inventors: Russ Davis, Elk City, OK (US); Jim Hayes, Denver, CO (US)

(21) Appl. No.: 15/494,541

(22) Filed: Apr. 23, 2017

(51) Int. Cl. A01K 11/00; A01K 29/00; G01S 19/14; G01S 19/42

(52) U.S. Cl. CPC A01K 11/004; A01K 29/005; H04L 67/02; G01S 19/42; G01S 19/14

(57) ABSTRACT

The current invention is system and application that can be used to track and locate livestock. The system uses a GPS tracking device that will be placed in the ear tag of the livestock. These devices will show the location of the livestock as well as information about the livestock. This will allow the farmers to keep an eye on their livestock via phone, computer, or laptop screen. The system will use an easy to read screen from a website or phone application that will allow a user to see the movement of the GPS tracking device, whether this be on their phone or computer.

### CROSS-REFERENCES TO RELATED APPLICATIONS (IF ANY)

None

### BACKGROUND

### 1. Field of the Invention

The present invention relates to a process for tracking and locating livestock.

### 2. Description of Prior Art

Ranchers and farmers have a need to manage their livestock. It includes keeping good records of each individual livestock individually and as a group and knowing where they are at any given moment. Livestock can get out of their fencing and the rancher or farmer needs to locate them and locate them quickly.

Many times a rancher and farmer needs to know a livestock's history including medical history in a easy to access location and format.

Tracking and keeping proper records of livestock directly effects the rancher and farmer's bottom line. There exists a need to quickly and easily track and locate livestock.

There is still room for improvement in the art.

### SUMMARY OF THE INVENTION

The current invention is system and application that can be used to track and locate livestock.

It uses a GPS tracking device that will be placed in the ear tag of the livestock. These devices will show the details of the age, weight, pregnant, and any other desired information. This will allow the farmers to keep an eye on their livestock via phone, computer, or laptop screen.

The system, in the preferred embodiment, can work like a smartphone application or a website application.

The system will use an easy to read screen from a website or phone application that will allow a user to see the movement of the GPS tracking device, whether this be on their phone or computer.

The innovative process is more efficient, effective, accurate and functional than the current art.

### BRIEF DESCRIPTION OF THE DRAWINGS

Without restricting the full scope of this invention, the preferred form of this invention is illustrated in the following drawings:

FIG. 1 shows an overview of how Users access the system;

FIG. 2 displays a system diagram;

FIG. 3 shows a sample login screen;

FIG. 4 shows a sample profile screen;

FIG. 5 shows the My Herds screen;

FIG. 6 shows the settings function;

FIG. 7 shows the map function; and

FIG. 8 shows the radius option.

### DESCRIPTION OF THE PREFERRED EMBODIMENT

There are a number of significant design features and improvements incorporated within the invention.

The current invention is a system and application 1 that has a GPS tracking device 10 that will be placed in the ear tag of the livestock. These GPS devices 10 will show the details of the cow age, weight, pregnant and other information. This will allow the farmers to keep an eye on their livestock via phone, computer, or laptop screen.

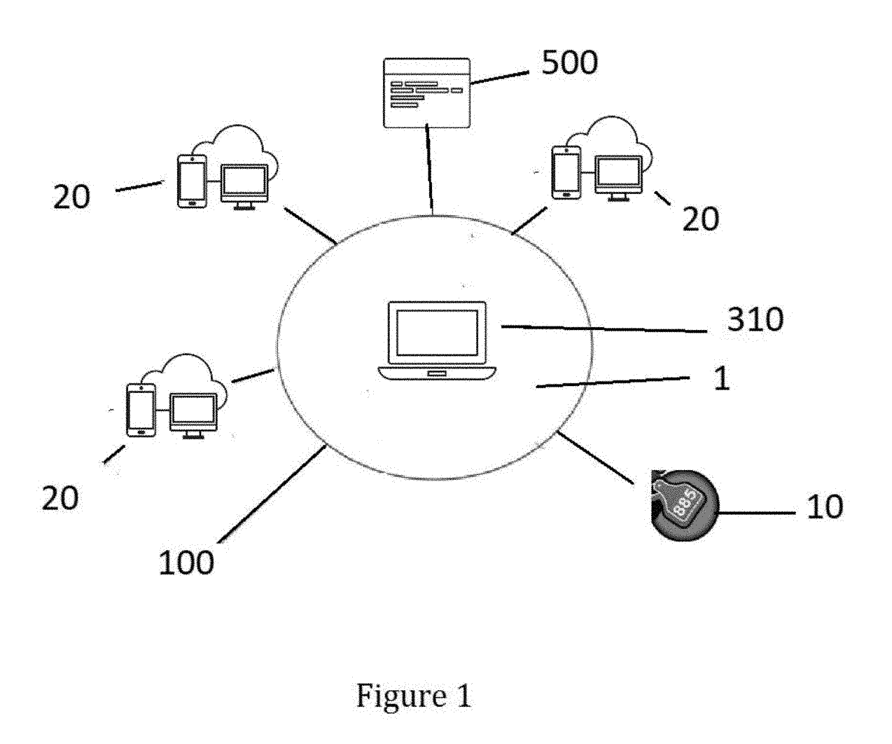

FIG. 1 displays the preferred embodiment of the system architecture 1 accessed through an Internet, Intranet and/or Wireless network 100. However, the system could be implemented on a device-to-device or client/server architecture as well. The system 1 is set to run on a computing device 20 or a website 500.

In FIG. 1, the system 1 is accessed from a user's computing device 20 through a web browser over HTTP and/or HTTPS protocols to a web site 500 or wireless network or cell phone to cell phone connection. A computing device 20, such as a cell phone, that can access the system 1 must have some version of a CPU, CPU memory, local hard disk, keyboard/keypad/input and display unit. The computing device 20 can be any desktop, laptop, tablet, smart phone or general purpose computing device with an appropriate amount of memory suitable for this purpose and an active connection to the Internet or a wireless network. Computing devices 20 like this are well known in the art and are not pertinent to the invention.

The GPS tracking device 10 will also access the system 1. The GPS tracking device 10 will have its own memory on which information any desired information about the livestock such as hear, age, weight, pregnant, and ID is stored and provided to the system.

The system 1, data and processing code can reside in the non-transitory memory 310 of the one or more computing devices 20 as well as the GPS device 10. The system 1 in the preferred embodiment would be written to act like a smart phone application (app) where the different apps can communicate with each. The system 1 may work with a central server as shown in FIG. 1 or in parallel which each computing device 10 or smartphone communicating with others within the system 1.

The system 1, data and processing code can reside in the non-transitory memory 310 of the one or more computing devices. The system 1 in the preferred embodiment would be written to act like a smart phone application (app) and would have a touch screen 100 to allow a user to swipe the screen when making choices and decisions.

The system 1, in the preferred embodiment, can work like a smartphone application or a website application.

The current invention is system and application that can be used to track and locate livestock.

The system's GPS tracking device 10 will be placed in the ear tag of the livestock in the preferred embodiment, although other locations can be used. The GPS device 10 will have its own memory to store desired information. This will allow the farmers to keep an eye on their cattle using a computing device 20 such as via a phone, computer, or laptop screen.

The system 1 will use an easy to read screen from a website or phone application that will allow a user to see the movement of the GPS tracking device 10, whether this be on their phone or computer.

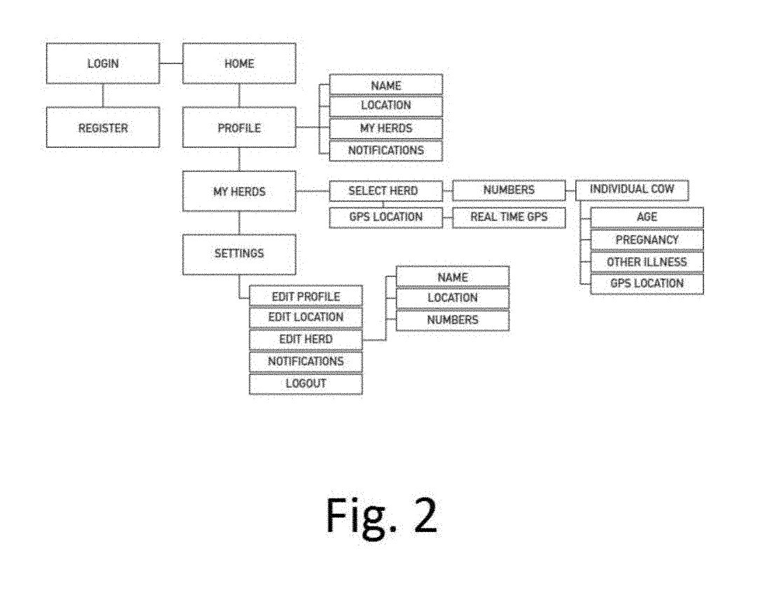

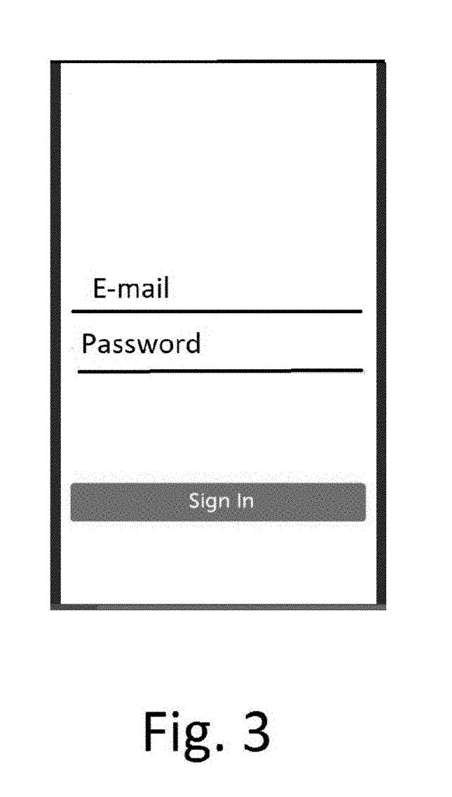

FIG. 2 shows the logic flow of the system 1. A user, such as a farmer or rancher, would register on the system 1. The would then login in using a login ID and password or another security means as shown in FIG. 3.

The user would go first to the home page where they can select the options of going to their profile, my herds or settings.

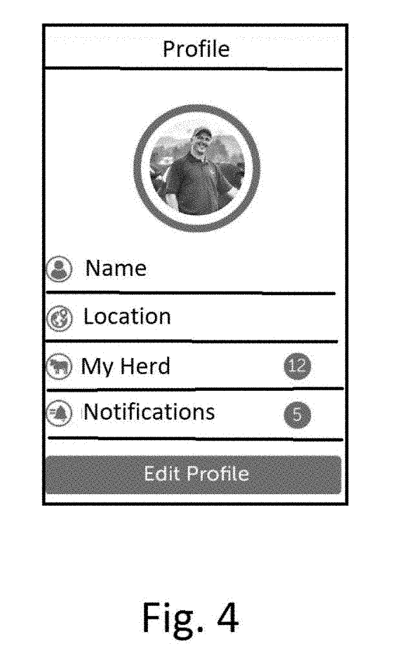

Their profile screen shows the user to set their name, their location, their herds and their notifications as shown in FIG. 4.

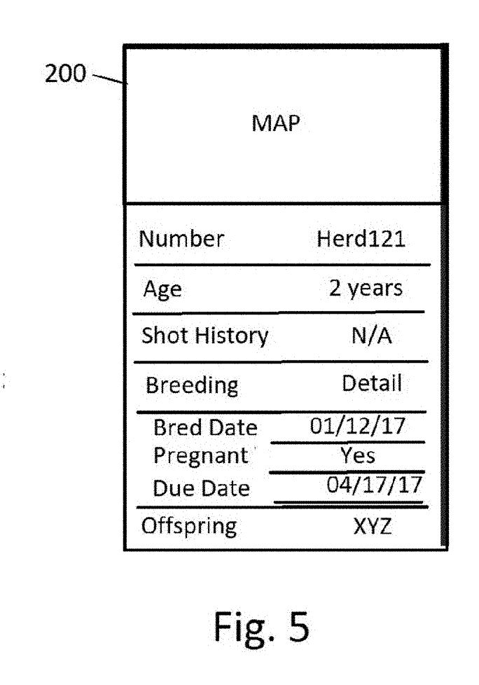

The my herds function allows the user to select a herd to receive numbers about the herd and information about an individual livestock such as a cows. It also gives the user the GPS location of the herd and individual members of the herd with real time GPS being provided. The information about an individual member can include age, pregnancy, illness and GPS location. A sample My Herds screen is shown in FIG. 5. The My Herds function will show the head's location on a map 200. Each herd can be given a unique Identification.

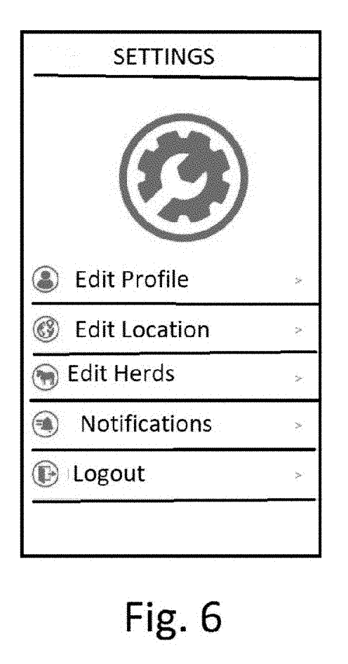

The settings option, as shown in FIG. 6, allows the user to edit their profile, their location, the herd information, their notifications and allow the user to logout of the system.

The edit profile screen would allow the user to set their name, their location, their herds and what type of notifications they would like to receive such as whether livestock has moved from a certain point or general reports about the herds.

The data in the database 310 and the system can have more than one herd. A herd would be defined as a group of livestock grouped together by the user.

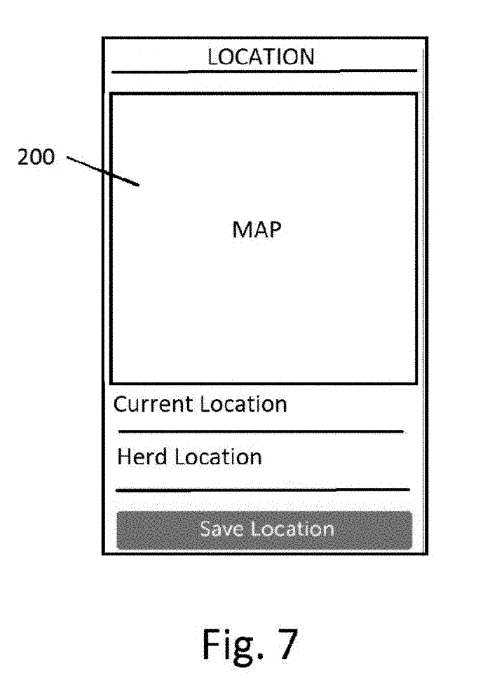

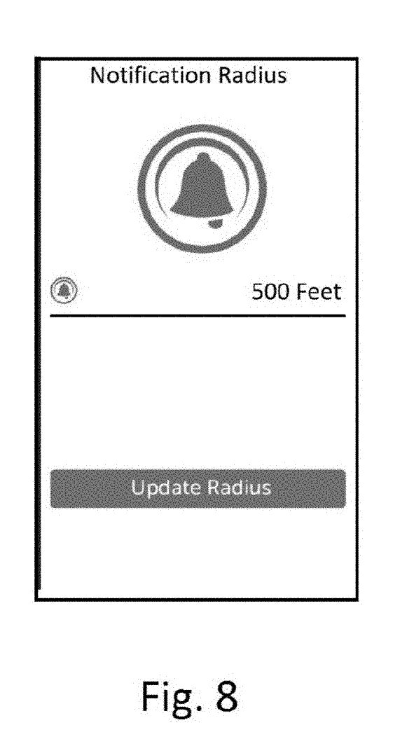

The system 1 will allow the user to see their location as well as the location of their herds on a map 200 using the GPS function as shown in FIG. 7. The system 1 will allow the user to set a radius for the herd as shown in FIG. 8 and receive a notification if the herd goes beyond that radius.

The user can set the number of livestock into each herd.

### ADVANTAGES

The system 1 and tag device 10 provides an easy method for farmers to track and locate their livestock. The current invention will be very user friendly for all types of farmers and ages.

### CONCLUSION

Although the present invention has been described in considerable detail with reference to certain preferred versions thereof, other versions are possible. Therefore, the point and scope of the appended claims should not be limited to the description of the preferred versions contained herein. The system is not limited to any particular programming language, computer platform or architecture.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A system comprising;
having a system that resides in the non-transitory memory of a computing device;
having a GPS device;
attaching the GPS device to an animal
placing information about the animal into the GPS device;
tracking the location of the animal using the GPS device; and
displaying the location on a screen.

2. A system according to claim 1 where the system is used with a smartphone.

3. A system according to claim 1 where the system is used with a tablet.

4. A system according to claim 1 where the system is used with a computer.

5. A system according to claim 1 where the information is one or more of a set of name, location, date and time.

6. A system according to claim 1 further comprising having a home, profile, my herds and settings option.

7. A system according to claim 6 where a user logs into the system.

8. A system according to claim 7 where the user logs into the system using an ID and password.

9. A system according to claim 6 where the profile function includes name, address, herds and notifications

10. A system according to claim 6 where My Herds function includes the herd identification and number in the herd.

11. A system according to claim 10 having the GPS location for the herd.

12. A system according to claim 10 further comprising having information about each animal in the herd.

13. A system according to claim 12 where the information on the animal includes age and GPS location.

14. A system according to claim 6 where the settings function allows the editing of the profile, herds and notification.

15. A system according to claim 14 where the settings function allows the editing of the herds name, location and numbers.

16. A system according to claim 1 setting a radius at a location and sending a notification if an animal moves beyond that radius.

17. A system according to claim 1 where the system is a smart phone application.

18. A system according to claim 1 where the system is run on a website.
